(19) United States
(12) Patent Application Publication
(10) Pub. No.: US 2024/0250342 A1
(43) Pub. Date: Jul. 25, 2024

(54) Immersion-Cooled Drive Battery and Motor Vehicle Comprising Such a Drive Battery

(71) Applicant: Bayerische Motoren Werke Aktiengesellschaft, Muenchen (DE)

(72) Inventor: Manfred Holzmann, Muenchen (DE)

(21) Appl. No.: 18/420,239

(22) Filed: Jan. 23, 2024

(30) Foreign Application Priority Data
Jan. 24, 2023 (DE) 10 2023 101 634.2

(51) Int. Cl. H01M 10/6568; B60L 58/26; H01M 10/6562

(52) U.S. Cl. CPC H01M 10/6568; B60L 58/26; H01M 10/6562; B60L 2240/545; H01M 2200/10; H01M 2220/20

(57) ABSTRACT

A drive battery for a motor vehicle includes a plurality of battery cells, each of which has a closed outgassing opening which opens in the event of a fault, wherein the battery cells are immersion cooled; a material layer, which lies against a face of the battery cells in which the outgassing opening has been made, wherein the material layer is made of a first material, wherein on the outer sides of the outgassing openings the first material includes cutouts, and a second material with a lower heat resistance than the first material is provided.

### CROSS REFERENCE TO RELATED APPLICATION

This application claims priority under 35 U.S.C. § 119 from German Patent Application No. 10 2023 101 634.2, filed Jan. 24, 2023, the entire disclosure of which is herein expressly incorporated by reference.

### BACKGROUND AND SUMMARY

The invention relates to a drive battery for motor vehicles, the battery cells of which are immersion cooled. The invention also relates to a motor vehicle comprising such a drive battery.

Drive batteries with immersion-cooled battery cells are known from the prior art. Such immersion-cooled drive batteries have the advantage that a saving can be made on coolers, such as cooling plates, which would otherwise lie against the battery cells. It is likewise known that in the event of a fault, such as a short circuit inside a cell, battery cells can undergo thermal runaway, which leads to outgassing of the battery cell. For such outgassing, the battery cells are provided with outgassing openings, for example a rupturing membrane.

An object of the present invention is to further optimize an immersion-cooled drive battery. This object is achieved by a drive battery according to claim 1 and by a motor vehicle according to claim 6. The dependent claims relate to advantageous refinements of the invention.

One exemplary embodiment of the invention provides a drive battery for a motor vehicle, comprising a multiplicity of battery cells, each of which has a closed outgassing opening which opens in the event of a fault, wherein the battery cells are immersion cooled; a material layer, which lies against a face of the battery cells in which the outgassing opening has been made, wherein the material layer is made of a first material, wherein on the outer sides of the outgassing openings the first material is cut out and a second material, in particular a different second material, with a lower heat resistance than the first material is provided. Owing to the lower heat resistance, the second material opens up the cutout, whereas the first material withstands the heat generated in the event of outgassing for a longer period of time. The first material could also withstand the heat throughout the outgas sing. This gives rise to the advantage that for the one part the region in front of the outgassing openings is filled (with the second material), with the result that cooling liquid or coolant of the immersion cooling system is displaced to the greatest possible extent as a result and cooling liquid can be saved, and for the other part a passage for the outgassing jet in the event of a fault is still provided quickly by the outgassing jet itself owing to the lower heat resistance of the second material.

According to another exemplary embodiment of the invention, the material layer is in the form of a mat. This has the effect of straightforward mountability and good suitability for series production.

According to another exemplary embodiment of the invention, on the outer sides of the outgas sing openings the first material is cut out in each case in the form of a cylinder with a diameter which is the same as or greater than the diameter of the associated outgassing opening. This makes it possible for the outgassing jet to emerge without hindrance.

According to another exemplary embodiment of the invention, in the cutouts in the first material at the outgassing openings, in each case the second material is provided in the form of a plug, which is provided with one or more channels on its outer contour or inside its outer contour, via which channels cooling liquid can be guided to that face of the battery cells in which the outgassing opening has been made. As a result, in this region, on the one hand the cooling liquid is mostly displaced and on the other hand, for temperature control purposes, cooling liquid is still guided to that side of the battery cell that is covered by the second material.

According to another exemplary embodiment of the invention, the plug is hollow on the inside or has multiple cavities. This makes it possible to displace the cooling liquid and keep the use of the second material low. Moreover, the plug is very lightweight as a result. For example, the plug could be made of plastic, in particular in the form of a thin layer or a film.

The present invention also provides a motor vehicle comprising such a drive battery.

A preferred exemplary embodiment of the present invention will be described below with reference to the appended drawings.

### BRIEF DESCRIPTION OF THE DRAWINGS

FIG. 1 shows a three-dimensional view of a drive battery according to one exemplary embodiment;

FIG. 2A shows a side view of a battery cell;

FIG. 2B shows a view of the battery cell from FIG. 2A from below;

FIG. 3 shows the battery cell with a material layer; and

FIG. 4 shows the battery cell with a material layer.

### DETAILED DESCRIPTION OF THE DRAWINGS

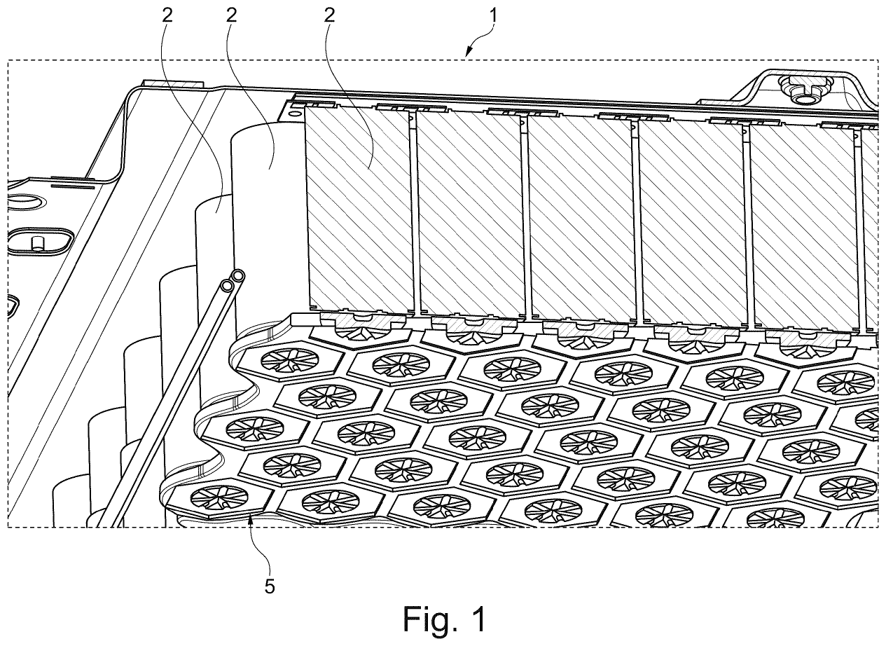

FIG. 1 shows a drive battery 1 according to one exemplary embodiment. This drive battery 1 is installed in a motor vehicle, which is not illustrated. The motor vehicle is an electrified motor vehicle, which at least temporarily is driven purely using battery electricity. In particular, it is a passenger car. The drive battery 1 comprises a multiplicity of battery cells 2, in which electrical energy is stored on an electrochemical basis and provided for a drive, in particular one or more electric motors, of the motor vehicle. The battery cells 2 are rechargeable and are, for example, lithium-ion cells. Furthermore, the battery cells 2 are connected to one another in series and/or in parallel. The battery cells 2 are accommodated in a battery housing in which cooling liquid flows around them, i.e. the battery cells 2 are immersion cooled. In the case of immersion cooling, the outer faces of the battery cells come into direct contact with a cooling liquid, which can then be circulated through a cooling circuit. For example, at least 50% of the outer faces of the battery cells 2 are in direct contact with the cooling liquid.

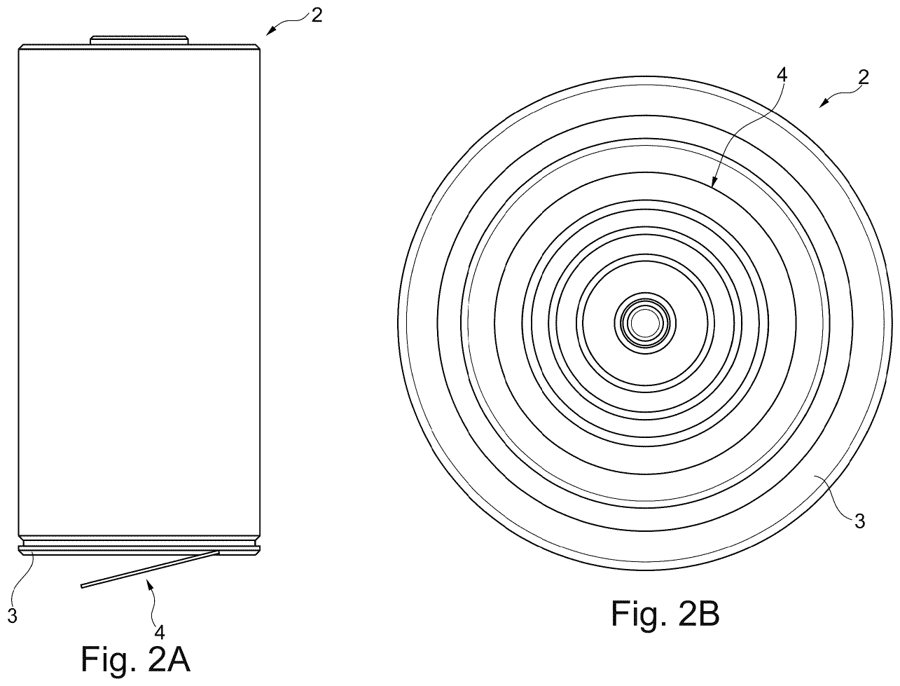

FIG. 2A shows a side view of a battery cell 2 and FIG. 2B shows a view of the battery cell from FIG. 2A from below. The battery cell is a cylindrical battery cell (also referred to as round cell). An outgassing opening 4, which in this exemplary embodiment has been made circularly in the underside 3, is formed in an underside 3 of the battery cell 2. This outgassing opening 4 is formed, for example, by a rupturing membrane. During normal operation, the outgassing opening 4 is fluid-tightly closed. When a certain pressure inside the battery cell, which is reached only in the event of a fault, is exceeded, the internal pressure causes the outgassing opening 4 to be pressed or forced into an open state, i.e. a rupturing membrane bursts or a cover is folded back, opened and/or forced open. FIG. 2A illustrates the outgassing opening 4 in an already open state, i.e. a cover covering the outgassing opening 4 is somewhat folded back.

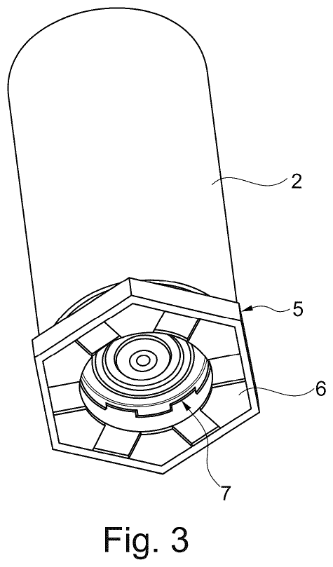

FIG. 3 shows the battery cell 2 with a material layer 5. A material layer 5 made of a first material 6 lies against a face in which the outgassing opening 4 has been made, or the underside 3 in the present exemplary embodiment. As can be seen in FIG. 1, the material layer 5 spans the undersides 3 of multiple battery cells 2 or all the battery cells 2 of the drive battery 1. The first material 6 of the material layer 5 is formed in one piece, in particular monolithically. In particular, the material layer 5 is in the form of a mat. The first material 6 has been cut out, or omitted, in the regions at each outgassing opening 4. In other words, the first material 6 has been cut out, or omitted, on the respective outer sides of the outgassing openings 4. In the present exemplary embodiment, these cutouts 7 are cylindrical with a cylinder axis which is congruent with the cylinder axis of the battery cell 2. The diameter of the cylindrical shape of the cutout 7 is somewhat greater than the diameter of the outgassing opening 4, with the result that the outgassing opening 4 can open into the cutout 7 unhindered by the first material.

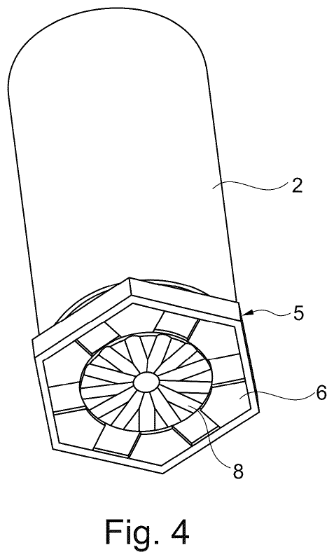

FIG. 4 shows the battery cell 2 with a material layer 5. The cutout 7 explained on the basis of FIG. 3 is filled with a second material 8, which has a lower heat resistance than the first material 6. In this case, it is either possible to form the cutouts 7, or form the material layer 5 with existing cutouts 7, in a first production step and to fill the cutouts 7 with the second material 8 in a second production step. It is also possible to form the material layer 5 with the first and the second material 6, 8 in one production step. It is likewise possible to fill the cutouts 7 with the second material 8 in the form of plugs. In this case, the plugs may be provided with channels or passages for the cooling liquid, with the result that cooling liquid is guided to the underside of the battery cells 2. The channels may be provided on the outer contour (at the point of contact between the inner side of the cutout 7 and the second material 8) in that the outer side has, for example, channels leading toward the battery cell 2. The channels may, however, also be arranged inside the outer contour. Moreover, the plug may have a hollow form on the inside, which makes it possible to save on material and weight. It is also possible to provide a plurality of such cavities inside a plug. In this case, each cavity is fluid-tightly sealed, with the result that cooling liquid cannot fill this cavity.

The heat resistance of the second material compared to that of the first material is to be chosen such that the second material breaks down as quickly as possible under the heat of an outgas sing jet and opens up the cutout, with the result that the outgassing jet can emerge from the battery cell 2 without hindrance. For example, expanded polystyrene or foam could be used as the second material. By contrast, the first material is to be chosen such that to the best possible extent it supports the battery cells 2 and protects them from damage owing to a mechanical action of force from below (bollard protection) and withstands the heat of the outgassing jet for as long as possible. For example, the second material has a lower melting temperature than the first material.

Closing the cutouts 7 with the second material 8 obtains the advantage that, as a result, this cavity is not filled with the cooling liquid of the immersion-cooled drive battery 1 but with the second material 8, which is more lightweight.

Whilst the invention has been illustrated and described in detail in the drawings and in the above description, this illustration and description is to be understood as being exemplary and not as being restrictive, and it is not intended to restrict the invention to the exemplary embodiment disclosed. The mere fact that particular features are mentioned in different dependent claims is not intended to indicate that a combination of these features could not also be used advantageously.

What is claimed is:

1. A drive battery for a motor vehicle, comprising:
a plurality of battery cells, each of which has a closed outgas sing opening which opens in an event of a fault, wherein the battery cells are immersion cooled;
a material layer, which lies against a face of the battery cells in which the outgassing opening has been made, wherein the material layer is made of a first material, wherein on outer sides of the outgassing openings, the first material includes cutouts, and a second material with a lower heat resistance than the first material is provided.

2. The drive battery according to claim 1, wherein the material layer is in the form of a mat.

3. The drive battery according to claim 2, wherein on the outer sides of the outgassing openings, the first material is cut out in a form of a cylinder with a diameter which is the same as or greater than a diameter of the associated outgassing opening.

4. The drive battery according to claim 3, wherein, in the cutouts in the first material at the outgassing openings, the second material is provided in a form of a plug, which is provided with one or more channels on an outer contour or inside the outer contour of the plug, via which channels cooling liquid can be guided to the face of the battery cells in which the outgassing opening has been made.

5. The drive battery according to claim 4, wherein the plug is hollow on the inside or has multiple cavities.

6. The drive battery according to claim 2, wherein, in the cutouts in the first material at the outgassing openings, the second material is provided in a form of a plug, which is provided with one or more channels on an outer contour or inside the outer contour of the plug, via which channels cooling liquid can be guided to the face of the battery cells in which the outgassing opening has been made.

7. The drive battery according to claim 6, wherein the plug is hollow on the inside or has multiple cavities.

8. The drive battery according to claim 1, wherein on the outer sides of the outgassing openings, the first material is cut out in a form of a cylinder with a diameter which is the same as or greater than a diameter of the associated outgassing opening.

9. The drive battery according to claim 8, wherein, in the cutouts in the first material at the outgassing openings, the second material is provided in a form of a plug, which is provided with one or more channels on an outer contour or inside the outer contour of the plug, via which channels cooling liquid can be guided to the face of the battery cells in which the outgassing opening has been made.

10. The drive battery according to claim 9, wherein the plug is hollow on the inside or has multiple cavities.

11. The drive battery according to claim 1, wherein, in the cutouts in the first material at the outgassing openings, the second material is provided in a form of a plug, which is provided with one or more channels on an outer contour or inside the outer contour of the plug, via which channels cooling liquid can be guided to the face of the battery cells in which the outgassing opening has been made.

12. The drive battery according to claim 11, wherein the plug is hollow on the inside or has multiple cavities.

13. A motor vehicle comprising the drive battery according to claim 1.
